(19) United States
(12) Patent Application Publication
(10) Pub. No.: US 2002/0199021 A1
(43) Pub. Date: Dec. 26, 2002

(54) Method and apparatus for using the type/length field in an ethernet mac header for carrying generic tags/labels

(76) Inventor: Niels Beier, Copenhagen (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/888,646

(22) Filed: Jun. 26, 2001

(51) Int. Cl. G06F 15/16; H04L 12/28; H04L 12/56

(52) U.S. Cl. 709/246; 709/230; 370/409

(57) ABSTRACT

Method and apparatus for transmitting generic information in an Ethernet Media Access Control (MAC) header. A packet that includes a MAC header and a payload is received. The packet is classified. Relevant generic information for the packet is determined. An Ethernet frame is formatted and the generic information inserted into the type/length field of the Ethernet frame MAC header. The formatted Ethernet frame is sent to a destination based on the generic information in the MAC header. The generic information is a tag/label.

### BACKGROUND

1. Field of the Invention

This invention relates to Ethernet frames, and more specifically to efficient use of an Ethernet frame header for carrying generic tags/labels.

2. Background Information

Ethernet is a local area network used for connecting computers, printers, workstations, terminals, servers, etc. This may be within the same building or amongst multiple buildings as in a campus. The low cost and standardized nature of Ethernet makes it a very interesting technology for backplanes. A number of blades (i.e., devices, modules) in a chassis or backplane may be connected using an Ethernet switch (or hub).

FIG. 1 shows a diagram of an IEEE 802.3 Ethernet frame. The blades/devices that are interconnected using an Ethernet switch, use standard Internet frames (IEEE 802.3) or Virtual Local Area Network (VLAN) tagged frames (IEEE 802.1P and IEEE 801.1Q) for communication. The Internet frame includes a header portion and a payload portion. The header portion includes a destination media access control (MAC) address of six bytes, a source MAC address of six bytes, and a type/length field of two bytes. The payload is anywhere from 0-1500 bytes. The payload may include data, commands as well as protocol header information such as an Internet Protocol (IP) header.

Currently, the type/length field is generally used to specify protocol information, for example, whether the payload is an IP packet, IPX packet, Appletalk frame, etc., or to specify the length of the packet. In many scenarios the type/length field will have the same value for almost all packets transferred. When a series of packets using the same protocol are being transferred, use of the type/length field in each packet to specify the protocol is redundant information. If a packet is received by a device/blade and additional information needs to be added or inserted into the packet, this may cause the packet to now have to be split into at least two or more separate packets when transported across the backplane if the additional information causes the payload to be larger than the 1500 byte IP frame maximum. Splitting the packet adds at a minimum 15 bytes of overhead, i.e., a new 14 byte MAC header and at least one extra byte for data. Moreover, fragmentation and reassembly typically are very expensive in terms of CPU cycles. Therefore, there is a need for more efficient use of the type/length field in a packet without causing the packet to then have to be fragmented into more packets.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of an IEEE 802.3 Ethernet frame;

FIG. 2 is a block diagram of an architecture using a switched Ethernet as a communication backplane according to an example embodiment of the present invention;

FIG. 3 is a flowchart of a process for using the type/length field in an Ethernet header according to an example embodiment of the present invention;

FIG. 4 is a diagram of a packet layout on a standard non-tag Ethernet backplane according to an example embodiment of the present invention; and

FIG. 5 is a diagram of a packet layout on a VLAN tagged backplane according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention relates to a method for using the type/length field in an Ethernet header to insert additional information into a packet without increasing the size of the packet, therefore, avoiding the need for packet fragmentation.

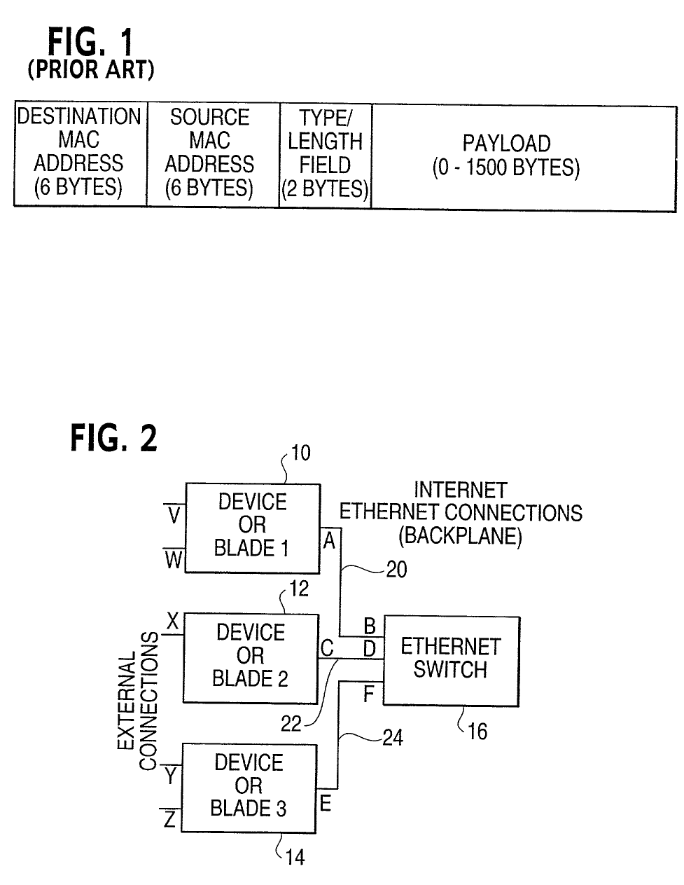

FIG. 2 shows a block diagram of an architecture using a switched Ethernet as a communication backplane according to an example embodiment of the present invention. A number of blades (e.g., devices or modules) 10, 12 and 14 are interconnected using an Ethernet switch (or hub) 16 through backplane connections 20, 22 and 24, respectively. Each blade connected to the backplane may have external connections (V thru Z).

When using an Ethernet backplane, there are several protocol options available for inter-blade communication. Protocols basically fall into two categories: (1) standard Ethernet protocols like IP, IPX, etc.; and (2) proprietary protocols. The present invention relates to the use of a proprietary protocol solution for inter-blade communication between blades 10, 12 and 14 through Internet switch 16. According to the present invention, the type/length field may be used to carry a generic tag/label. In current protocols the tags have no predefined meaning, but are decided at run time. According to the present invention, efficient use of the MAC header allows for transporting 1500 byte IP and IPX frames across the external connections V-Z using a generic tag on a standard Ethernet segment without any need for packet fragmentation.

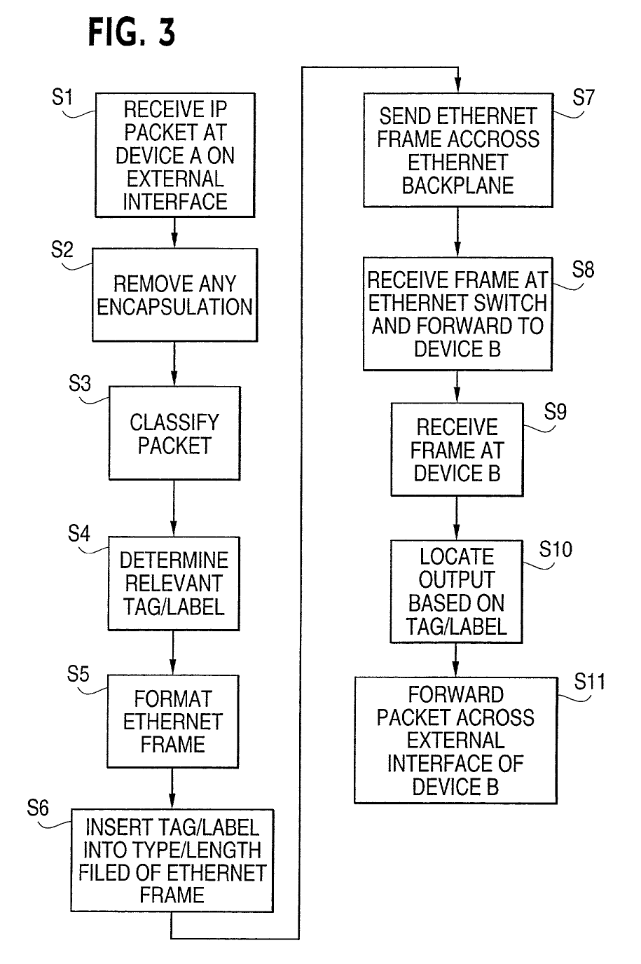

FIG. 3 shows a flowchart of a process for using the type/length field in an Ethernet header according to an example embodiment of the present invention. A 1500 byte IP packet is received on external connection W on blade 10, S1. This may be, for example, a point-point protocol (PPP) link. Any PPP encapsulation used on the external connection may be removed S2. The remaining portion of the packet is 1500 bytes long. The packet may be classified S3, and the relevant tag/label specifying the external connection Y on blade 14 decided S4. An Ethernet frame is formatted S5, and the tag/label inserted as the type/length field S6. The Ethernet frame may be formatted containing the MAC address of blade 10 as source address and the MAC address of blade 14 as destination address. The remaining 1500 bytes may be used to store the IP frame. The Ethernet frame may be sent on interface A of blade 10 using connection 20 of the Ethernet backplane S7. The Ethernet switch receives the packet on interface B and forwards the packet on interface F, S8. The packet may be received on interface E on device 14, S9. Blade 14 locates the output based on the tag/label in the packet S10. If the labels/tags are of local significance between the blades, the source MAC address may also be used in the classification process. The packet may then be forwarded on external connection Y using interface specific encapsulation S11.

The present invention may be applied to connection of independent devices like routers, voice gateways and secure socket layer (SSL) accelerators. Devices that may be equipped with Ethernet interfaces may incorporate the present invention to stack the devices or share resources between the devices. For example, if one device contains a crypto accelerator, the crypto accelerator on this device may be used by a number of routers and/or other devices. The present invention allows use of standard switching components in the backplane by a chassis based router or server rack.

The tag/label according to the present invention may be either global on the backplane or only have local significance between two blades, e.g., the same tag/label value may have a different meaning when a blade communicates with two different blades. Tag/label values may be allocated and freed dynamically. A single master device/blade may, for example, be responsible for tag/label allocation and distribution. The master blade/device may then use a predefined label/tag (e.g., tag/label 0) to notify the other blades/devices how the tag/label values should be interpreted. Moreover, a device/blade may interpret the payload to determine what the type/length is revised to and/or how it should be interpreted.

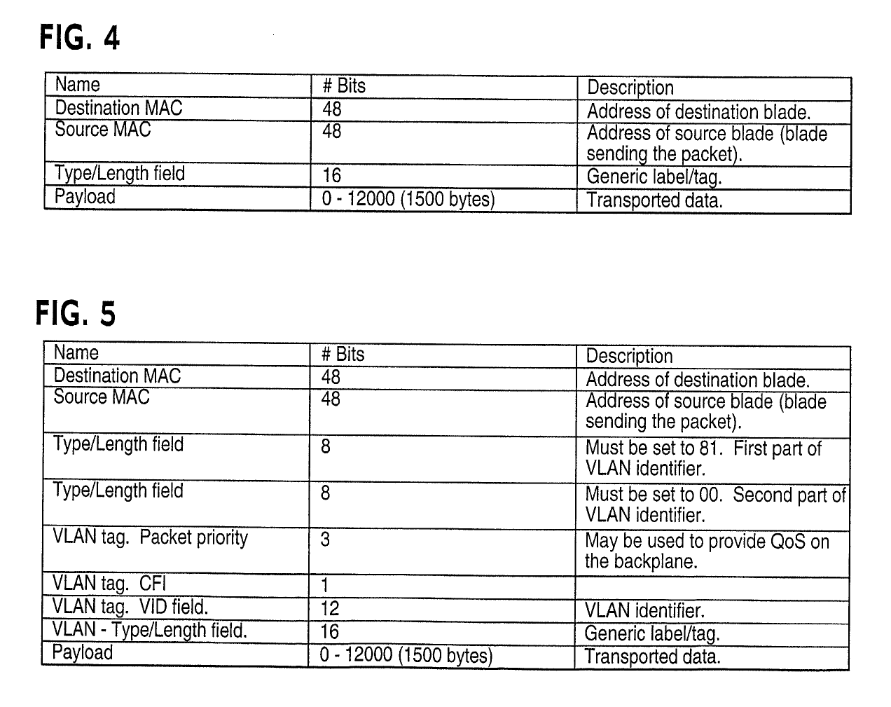

FIG. 4 shows a diagram of a packet layout on a standard non-tag Ethernet backplane according to an example embodiment of the present invention. This packet layout applies to an Ethernet frame as defined in the IEEE 802.3 standard. As shown in FIG. 4, the destination MAC field is 48 bits and contains the address of a destination blade. The source MAC field is 48 bits and contains the address of a source blade or the blade sending the packet. The type/length field is 16 bits and contains a generic label/tag. The payload may be anywhere from 0 to 12000 bits (i.e., 1500 bytes) and transports the data.

FIG. 5 shows a diagram of a packet layout on a VLAN tagged backplane according to an example embodiment of the present invention. This packet layout relates to the IEEE 802.1P and IEEE 801.1Q standards. In this layout, the destination MAC field is 48 bits and contains the address of a destination blade. The source MAC field is also 48 bits and contains the address of a source blade. In this layout, the type/length field is 16 bits where 8 bits may be set to 81 and describe the first part of a VLAN identifier. The second 8 bits of the type/length field may be set to 00 and define a second part of a VLAN identifier. The VLAN tag.Packet priority. Field is 3 bits and describes or used to provide the quality of service (QoS) on the backplane. Another VLAN tag.CFI. field is 1 bit. A third VLAN tag.VID. field is 12 bits and defines a VLAN identifier. A VLAN type/length field is 16 bits and carries a generic label/tag according to the present invention. A payload field may be anywhere from 0 to 12000 bits (1500 bytes) and carry the transported data.

A blade according to the present invention may be a router, server, encryption device, voice processor, or any other processing device. A protocol used by all blades may define the type/length field for all devices, or each device may interpret the payload to determine what the type/length field may have been revised to. This allows each blade to use special functions of other blades, therefore, saving room on that particular blade from having to incorporate the function itself. The use of standard Ethernet switches, load sharing, and dynamic reconfiguration of the protocol defining the type/length field make the present invention highly advantageous.

Methods according to the present invention are advantageous in that they allow efficient use of the MAC header making it possible to afford 1500 bytes of IP and IPX frames between external connections using a generic tag on a standard Ethernet segment without any need for packet fragmentation. Due to the use of standard Ethernet technology, off the shelf hardware may be used to interconnect the blades/devices. Moreover, Ethernet switches typically support QoS using VLAN priorities, therefore, by assigning different VLAN QoS levels to the different labels/tags, these QoS features may be utilized and thereby QoS enabling the backplane.

It is noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for transmitting generic information in an Ethernet Media Access Control (MAC) header comprising:
receiving a packet, the packet including a MAC header and a payload;
classifying the packet;
determining relevant generic information for the packet;
formatting an Ethernet frame and inserting the generic information into the type/length field of the Ethernet frame MAC header; and
sending the formatted Ethernet frame to a destination based on the generic information in the MAC header.

2. The method according to claim 1, wherein the generic information comprises a tag/label.

3. The method according to claim 1, further comprising receiving the Ethernet frame at a first device connected to an Ethernet backplane, the destination being a second device connected to the Ethernet frame.

4. The method according to claim 3, further comprising interconnecting the first device and the second device on the Ethernet backplane via an Ethernet switch/hub.

5. The method according to claim 1, further comprising classifying the packet based on the con tents of the packet payload.

6. The method according to claim 1, wherein the packet comprises one of an Internet Protocol (IP) packet and an Internetwork Packet Exchange (IPX) packet.

7. The method according to claim 1, wherein the Ethernet frame comprises a non-tagged IEEE 802.3 frame.

8. The method according to claim 1, wherein the Ethernet frame comprises a tagged Virtual Local Area Network (VLAN) IEEE 802.1P/802.1Q frame.

9. The method according to claim 1, wherein the generic information has significance globally to all devices connected to an Ethernet backplane.

10. The method according to claim 1, wherein the generic information has significance only locally to fewer than all devices connected to an Ethernet backplane.

11. A device connected to an Ethernet backplane comprising:
an input interface, the input interface capable of receiving a packet, the packet including a MAC header and a payload;
at least one processor, the at least processor capable of classifying the packet, determining relevant generic information for the packet, formatting an Ethernet frame, and inserting the generic information into the type/length field of the Ethernet frame MAC header; and
an output interface, the output interface capable of sending the formatted Ethernet frame to a destination based on the generic information in the MAC header.

12. The device according to claim 11, wherein the device comprises one of a router, a server, an encryption device, a voice processor, and a computing device.

13. The device according to claim 11, wherein the output interface connects to one of an Ethernet backplane and an external connection.

14. The device according to claim 11, wherein the generic information comprises a tag/label.

15. An apparatus comprising a storage medium with instructions stored therein, the instructions when executed causing a computing device to perform:
receiving a packet, the packet including a MAC header and a payload;
classifying the packet;
determining relevant generic information for the packet;
formatting an Ethernet frame and inserting the generic information into the type/length field of the Ethernet frame MAC header; and
sending the formatted Ethernet frame to a destination based on the generic information in the MAC header.

16. The apparatus according to claim 15, further comprising classifying the packet based on the contents of the packet payload.

17. The apparatus according to claim 15, wherein the packet comprises one of an Internet Protocol (IP) packet and an Internetwork Packet Exchange (IPX) packet.

18. The apparatus according to claim 15, wherein the Ethernet frame comprises a non-tagged IEEE 802.3 frame.

19. The apparatus according to claim 15, wherein the Ethernet frame comprises a tagged Virtual Local Area Network (VLAN) IEEE 802.1P/802.1Q frame.

20. The apparatus according to claim 15, wherein the generic information has significance one of globally to all devices connected to an Ethernet backplane and only locally to fewer than all devices connected to an Ethernet backplane.
